(19) United States
(12) Patent Application Publication
(10) Pub. No.: US 2003/0204790 A1
(43) Pub. Date: Oct. 30, 2003

(54) Computer main board on/off testing device, method and system

(75) Inventors: Dong-Bo Hao, Shen-Tsen City (TW); Moto Huang, Hsin-Tien Shin (TW); Bob Chen, Hsin-Tien Shin (TW)

Correspondence Address: J C PATENTS, INC., 4 VENTURE, SUITE 250, IRVINE, CA, 92618, US

(73) Assignee: VIA TECHNOLOGIES, INC., TAIPEI (TW)

(21) Appl. No.: 10/064,812

(22) Filed: Aug. 20, 2002

(30) Foreign Application Priority Data
Apr. 30, 2002 (TW) 91108950

(51) Int. Cl. G06F 11/26

(52) U.S. Cl. 714/48

(57) ABSTRACT

FILE:8774USF.RTF20A computer main board on/off testing device, method and system. The testing device at least includes the hardware circuits of a command translation unit and a test procedure control unit. The hardware circuits are connected onto a standard interface of the computer main board so that the power switch and reset switch within the computer main board are connected by connection wires. The main board is switched and reset automatically by executing the program inside a test control unit. Codes issued from the main board are translated through a command translation unit. Working conditions during on/off switching, reset and power management suspend/wake up operations are assessed and results of the test are registered.

### CROSS REFERENCE TO RELATED APPLICATIONS

This application claims the priority benefit of Taiwan application serial no. 91108950, filed Apr. 30, 2002.

### BACKGROUND OF INVENTION

The present invention relates to a computer main board. More particularly, the present invention relates to a computer main board on/off testing device, method and system.

In step with the rapid progress in electronic technology, the computer has become an indispensable tool for information processing. As production of computers continues to accelerate, the stability of the computer main board is becoming increasingly important. To ensure stability in computer main boards, the boards must pass a series of standard tests. On/off tests, reset tests and suspend/wake up tests are major tests a computer main board has to be subjected to before shipment. In the past, testing was executed by operating the power on/off and reset switches manually. However, manual operation not only limits the number of repetitions, so that problems requiring frequent or continuous switching are difficult to find, but is also highly inefficient and inaccurate and thus leads to a non-unified quality standard.

Although activating cyclic switching through a timing switch similar to the CMOS time-setting switch inside a main board may avoid the problems due to manual operation, the number of tests is recorded after the operating system is activated. If the computer breaks down or pauses before getting into the operating system, testing will be discontinued and no more results will be registered. Furthermore, actions executed at software startup may be different from hardware actions so that hardware errors may not be detected.

### SUMMARY OF INVENTION

Accordingly, one object of the present invention is to provide a computer main board on/off testing device, method and system. The system repeatedly executes a main board on/off test, a reset test, a power management suspend/wake up test, then registers the results and displays the results automatically. Hence, no manual operation is required and the deletion of test results due to system failure is avoided.

To achieve these and other advantages in accordance with the purpose of the invention, as embodied and broadly described herein, the invention provides a computer main board on/off testing device. The device includes a command translation unit and a test procedure control unit. The command translation unit is coupled to the computer main board through a standard interface. The command translation unit receives write-in data from a special port address and translates the write-in data. The write-in data is also latched up for subsequent use. The test procedure control unit is coupled to the command translation unit and the computer main board. The test procedure control unit sends test control commands sequentially according to a preset test procedure and reads back the latched write-in data inside the command translation unit to determine if the computer main board is working normally. The results of such testing steps are also recorded.

In this embodiment, when the computer main board on/off testing device is applied to test a computer main board, the on/off testing device further includes a test result display unit and a test procedure selection unit. The test result display unit is coupled to the test procedure control unit to display the test results. The test procedure selection unit is coupled to the test procedure control unit to select the aforementioned preset test procedure. The preset test procedures include steps for conducting the on/off test, the reset test and the power management suspend/wake up test.

The computer main board on/off testing device further includes a write-in data display unit for displaying the latched write-in data inside the command translation unit. The test control commands include a power on/off command and a reset command. The standard interface linking the computer main board on/off testing device and the main board is a peripheral component interconnect (PCI) interface and the special port address for detecting errors is the input/output port address 80H. During testing, the number of tests and the number of errors are registered so that the results can be displayed. Moreover, the interval separating the execution of test control commands in a test procedure can be pre-programmed.

This invention also provides a computer main board on/off testing method. The method includes the following steps. According to a preset test procedure, test control commands are transmitted sequentially to control on/off switching and resetting of the computer main board. Through a standard interface in the computer main board, write-in data from a special port address is translated to determine if the computer main board is operating normally. In the meantime, testing results are registered or displayed at the same time.

The test control commands include a power on/off command and a reset command. The preset test procedure includes steps for conducting an on/off test, a reset test and a power management suspend/wake up test. The standard interface of the computer main board is a PCI interface and the special port address for detecting errors is the input/output port address 80H. Furthermore, the testing method also displays test results that include the number of tests and the number of errors. Moreover, the interval separating each test control command can be preset.

In brief, the computer main board on/off testing device, method and system according to this invention conducts on/off tests, reset tests and power management suspend/wake up tests automatically instead of manually. The number of repeated tests and the testing interval may be adjusted on demand. Since the testing results are registered and displayed automatically, deletion of testing results will not occur due to system failure.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram showing a computer main board on/off testing system according to one preferred embodiment of this invention;

FIG. 2 is a flow chart showing the sequence of steps carried out in an on/off test procedure according to one preferred embodiment of this invention;

FIG. 3A is a flow chart showing the first of a sequence of steps carried out in a reset test procedure according to one preferred embodiment of this invention;

FIG. 3B is a flow chart showing the second of a sequence of steps carried out in the reset test procedure;

FIG. 4A is a flow chart showing the first in a sequence of steps carried out in a power management suspend/wake up test procedure according to one preferred embodiment of this invention;

FIG. 4B is a flow chart showing the second of a sequence of steps carried out in the power management suspend/wake up test procedure; and

FIG. 5 is a block diagram of a test procedure control unit according to one preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and description to refer to the same or like parts.

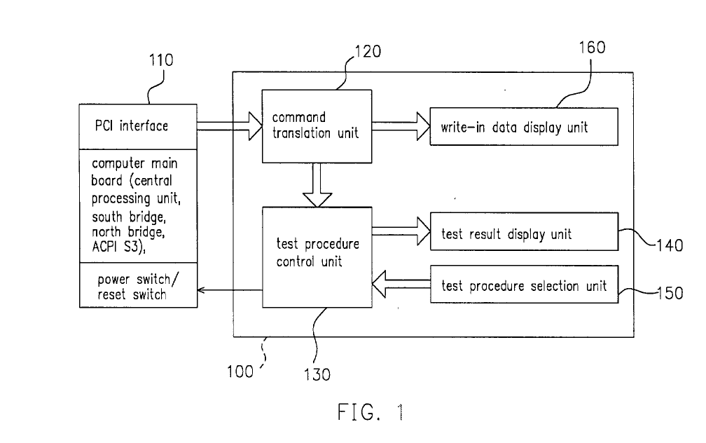

FIG. 1 is a block diagram showing a computer main board on/off testing system according to one preferred embodiment of this invention. As shown in FIG. 1, the system includes a computer main board 10 and a computer main board on/off testing device 100. The computer main board 110 includes a standard interface such as a peripheral component interconnect (PCI) interface, a power on/off switch, a reset switch, a central processing unit (CPU), an advanced configuration & power interface (ACPI) and a basic input/output system (BIOS) such as an Award BIOS (or a Phoenix BIOS). The computer main board on/off testing device 100 includes at least a command translation unit 120 and a test procedure control unit 130. To display test results, the system may include a test result display unit 140. If a user wants more flexibility in selecting the testing procedure, a test procedure selection unit 150 may also be included. Furthermore, if error detection capacity is required, a write-in data display unit 160 may also be included.

The command translation unit 120 is coupled to the computer main board 110 through the PCI interface. The computer main board 110 according to this embodiment will output non-FF write-in data from the special error detection port address having an input/output port address of 80H at system start up or restart of the Award BIOS. The command translation unit 120 receives the write-in data. After translating the write-in data, the translated data is latched and preserved for determining if the operating conditions of the computer main board 110 at start up are normal or not. In this embodiment, the command translation unit 120 may be implemented using a programmable logic device GAL16V8, for example. The test procedure control unit 130 is coupled to the command translation unit 120 and to the power switch and reset switch of the computer main board 110 through connecting wires. According to a preset test procedure, the test procedure control unit 130 issues test control commands sequentially such as power on/off commands or reset commands to control the switching and resetting of the computer main board 110. Thereafter, the latched write-in data inside the command translation unit 120 is retrieved so that functionality of the computer main board can be determined. In the meantime, test results such as the number of tests and the number of errors are registered. In this embodiment, the test procedure control unit 130 may be implemented using a single-chip microprocessor 8031, a latching unit 74LS373 and an EEPROM 2864. The test result display unit 140 is coupled to the test procedure control unit 130 for displaying the test results.

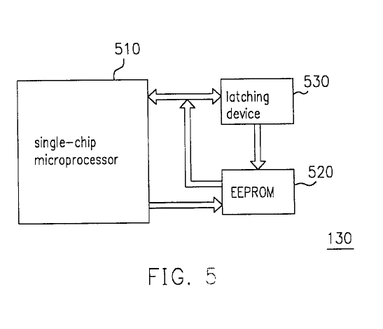

FIG. 5 is a block diagram of a test procedure control unit according to one preferred embodiment of this invention. As shown in FIG. 5, the signal-chip microprocessor 510 inside the test procedure control unit 130 immediately sends an address to the EEPROM 520 to retrieve an execution instruction as soon as power to the computer is turned on. The address of the execution instruction includes a high byte and a low byte. The high byte is sent to the EEPROM 521 directly from the single-chip microprocessor 510. The low byte containing 8 bits is transmitted to the latching unit 530 through a data/address bus before re-transmitting to the EEPROM 520. When the EEPROM 520 receives both the high byte and the low byte so that a full address is obtained, instruction is retrieved from the address and transmitted to the single-chip microprocessor 510 through a data (instruction)/address bus. The single chip microprocessor 510 immediately executes the instruction to start the test procedure.

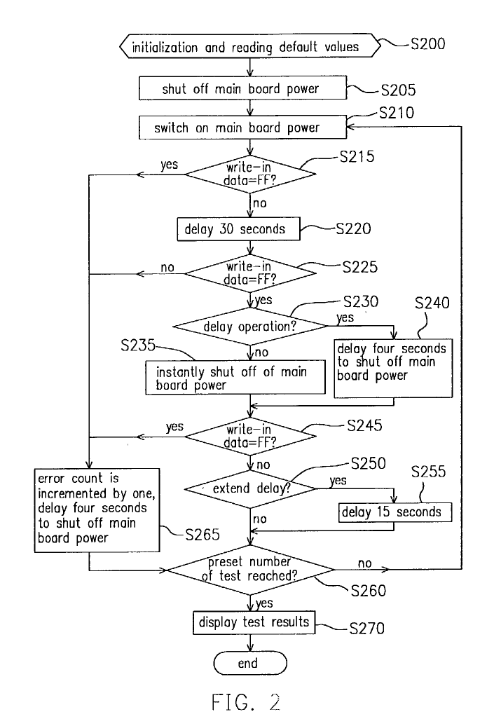

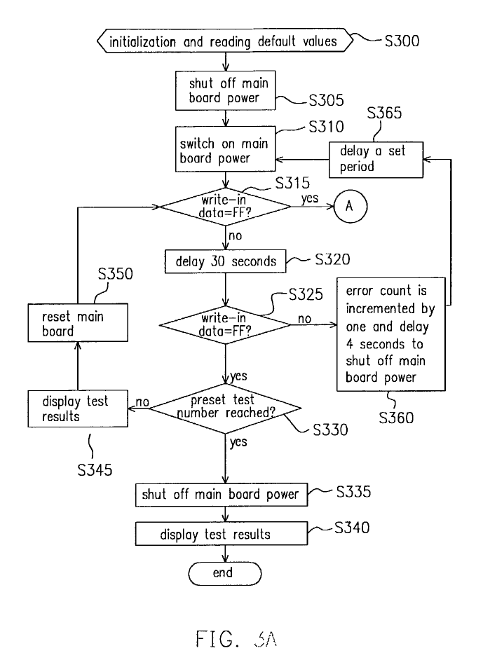

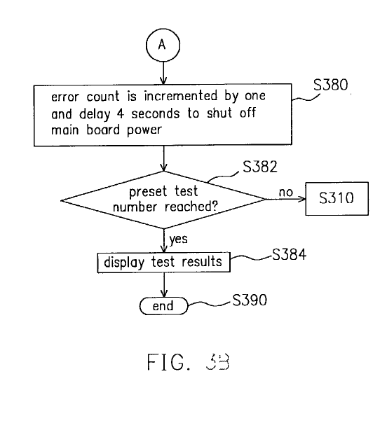

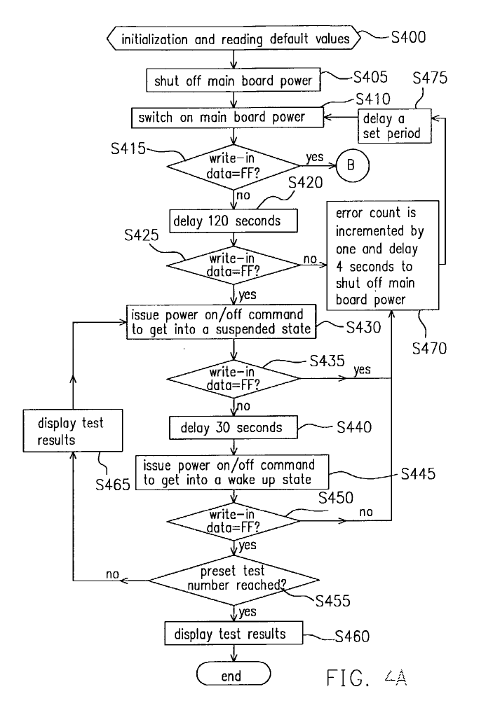

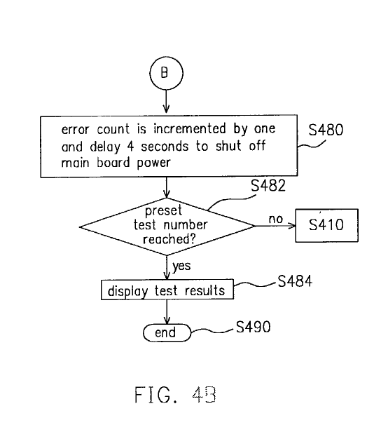

The test procedure selection unit 150 is coupled to the test procedure control unit 130 for setting the preset test procedure. The preset test procedure includes the on/off test procedure in FIG. 2, the reset test procedure in FIG. 3 and the power management suspend/wake up test procedure in FIG. 4. These test procedures can be created using the program codes of a single-chip microprocessor such as 8031 single-chip microprocessor. The intervals between switching from on to off, from off to on and reset can be set. Furthermore, the number of loops in each procedure can be set to 10, 100, 200 times or an infinite number of times on demand. The write-in data display unit 160 displays the write-in data latched inside the command translation unit 120 to serve as a reference in error detection.

FIG. 2 is a flow chart showing the sequence of steps carried out in an on/off test procedure according to one preferred embodiment of this invention. As shown in FIG. 2, the procedure begins at initialization and reading of default values in step S200. Aside from setting the start-up values of the computer main board on/off testing device 100, this step also reads in the selected values from the test procedure selection unit 150 to serve as a reference. To avoid unexpected start-up conditions due to the presence of standby power in the computer main board 110, the power switch is held down for at least four seconds no matter whether the switch is originally “on” or “off”. Hence, the main board power is completely shut off in step S205 before starting the test.

The testing procedure starts by issuing a power switch connect command to switch on the main board power in step S210. The write-in data latched within the command translation unit 120 is read and the value retrieved is checked to determine if the value is FF in step S215. Since the execution of starting up BIOS is still ongoing, a read-out value of FF indicates the execution of BIOS is unsuccessful. The procedure jumps to the execution of step S265. In step S265, the error count is incremented by one and a four-second delay is used to shut off power to the main board before decision to begin the next round of testing is assessed. On the contrary, if the value is not FF, step S220 is carried out by waiting for another 30 seconds until the execution of the BIOS program is completed. Obviously, a person skilled in the art will know that there is a certain relation between the length of the waiting time and the type of main board. Step S225 is executed to read the value of the write-in data. If the read-out value is still not “FF”, execution of the main board BIOS program remains unsuccessful. However, if the value is FF, a switch-off testing may commence.

Before initiating the switch-off testing, the selected switching off mode has to be assessed to determine if some delay is required in step S230. If delay is required, step S240 is executed to delay for four seconds so that the power to the main board is shut off. Otherwise, power to the main board is instantly shut off in step S235. Thereafter, the write-in data is checked again to determine if the value is FF in step S245. Since the circuit of the command translation unit 120 is designed such that a non-FF value is generated when the main board is switched off, a read-out value of FF indicates an unsuccessful switching. Step S265 is next executed to increment the error count by one and a four second delay is exercised to turn off power to the main board before going to step S260. Otherwise, step S250 is executed to determine if an extension of the delay period is required. When an extension of delay period is required, an additional delay of 15 seconds is exercised in step S255 before executing step S260. In step S260, the number of tests already executed is checked with a preset number. If the preset number is still not reached, the next testing loop is initiated by jumping back to step S210. On the other hand, if the preset number is reached, the test is complete. Results including total number of test cycles and the total number of error occurrences are displayed in step S270.

FIG. 3 is a flow chart showing the sequence of steps carried out in a reset test procedure according to one preferred embodiment of this invention. For convenience of explanation, FIG. 3 is divided into two flow charts of FIGS. 3A and 3B. As shown in FIG. 3, the procedure begins at initialization and reading of default values in step S300. Aside from setting the start-up values of the computer main board on/off testing device 100, this step also reads in the selected values from the test procedure selection unit 150 to serve as a reference. To avoid unexpected start-up conditions due to the presence of standby power in the computer main board 110, the power switch is held down for four or more seconds no matter whether the switch is originally “on” or “off”. Hence, the main board power is completely shut off in step S305 before starting the test.

The testing procedure starts by issuing a power switch connect command to switch on the main board power in step S310. The write-in data latched within the command translation unit 120 is read and the value retrieved is checked to determine if the value is FF in step S315. Since the execution of starting up BIOS is still ongoing, a read-out value of FF indicates the execution of BIOS is unsuccessful and the reset operation cannot proceed. Hence, procedure A is executed to boot the related start-up program again. If the read-out value is not FF, step S320 is carried out by waiting for another 30 seconds until the entire BIOS program is executed. Thereafter, step S325 is executed to read the value of the write-in data. If the value is still not FF, this indicates execution of the main board BIOS is still unsuccessful and step S360 is executed. In step S360, the error count is incremented by one and a four-second delay is used to shut off power to the main board. After another delay period in step S365, control jumps to step S310 for re-entering into a testing loop. However, if the read-out value is FF, step S330 is executed to check if the target test number is reached. If the target number is still not reached, current test results are displayed in step S345 and a reset command is issued to reset the main board as shown in step S350. Next, step S315 is executed to continue with the looping test. On the other hand, if the target number is reached in step S330, the testing is complete. Step S335 is executed to shut off power to the main board. Lastly, step S340 is executed to display the final test results.

Procedure A for re-starting the computer main board as shown in FIG. 3B involves several steps. In step S380, the error count is incremented by one and a four-second delay is used to shut off power to the main board. In step S382, the number of resets are checked to determined if the preset number of resets is reached. If the preset number is reached, step S384 is executed to display the test results followed by the termination step S390. Otherwise, step S310 is executed to turn on the power again till start-up is successful. Thereafter, step S320 to carry out reset testing is executed via step S315. Because the purpose of having this testing procedure is to conduct a reset test, the procedure A may be replaced by an ending step to stop the test since the reset test, in a meaning, can not be performed due to the unsuccessful start-up of the operating system.

FIG. 4 is a flow chart showing the sequence of steps carried out in a power management suspend/wake up test procedure according to one preferred embodiment of this invention. For convenience of explanation, FIG. 4 is divided into two flow charts of FIGS. 4A and 4B. The S3 configuration in an advanced configuration & power interface (ACPI) is an energy-saving mode, that is, a suspend-to-RAM mode for power management. The energy-saving mode is activated through system hardware and the operating system. When the computer is in idle, energy may be saved by stepping into the S3 energy-saving configuration according to the particular settings of the operating system. In the S3 mode, operating parameters are transferred to a memory unit and power is supplied to the memory unit only. Other computer elements are in an S3 suspended state and receive minimal standby power. The computer may be awakened and returned to its normal operating state by reading data from the memory unit. To test the suspend/wake up procedure, the operating system may be set in such a way that the S3 suspended state is triggered when the power switch is pushed and awakened from the S3 suspended state when the power switch button is pushed again. With this configuration, testing is conveniently carried out by issuing a power switching command together with the generation of appropriate delay.

As shown in FIG. 4A, the procedure begins at parameter initialization and the default value reading in step S400. Aside from setting the start-up values of the computer main board on/off testing device 100, this step also reads in the selected values from the test procedure selection unit 150 to serve as a reference. To avoid unexpected start-up conditions due to the presence of standby power in the computer main board 110, the power switch is held down for four or more seconds no matter whether the switch is originally “on” or “off”. Hence, the main board power is completely shut off in step S405 before starting the test.

The testing procedure starts by issuing a power switch connect command to switch on the main board power in step S410. The write-in data latched within the command translation unit 120 is read and the value retrieved is checked to determine if the value is FF in step S415. Since the execution of the start up BIOS is still ongoing, a read-out value of FF indicates the execution of BIOS is unsuccessful and the S3 suspend/wake up test cannot proceed. Hence, procedure B is executed to boot the related start-up program again. If the read-out value is not FF, step S420 is carried out by waiting for another 120 seconds until the entire BIOS program and necessary operating system program are executed. In this manner, a sufficient time is provided to enable the S3 suspend/wake up function. Thereafter, step S425 is executed to read the value of the write-in data. If the value is still not FF, this indicates execution of the main board BIOS is still unsuccessful and step S470 is executed. In step S470, the error count is incremented by one and a four-second delay is used to shut off power to the main board. After another delay period in step S475, control jumps back step S410 for re-entering into a testing loop. However, if the read-out value is FF, the S3 suspend/wake up test may commence.

The S3 suspend/wake up test is initiated by issuing a power switch connect command to bring the main board into a suspended state in step S430. The write-in data is read and checked to determine if the read-out value is FF in step S435. Since the circuit of the command translation unit 120 is designed such that a non-FF value is obtained when the power supply of the main board is shut off, a read-out value of FF indicates an unsuccessful switch to the suspended state. Step S470 is executed so that the error count is incremented by one and a four second delay is provided to shut off power to the main board. If the read-out data is not the value FF, step 440 is executed to exercise a delay of 30 seconds. Thereafter, a power switch connect command is issued in step S445 to wake up the main board. In step S450, the write-in data is again read and the read-out value is again assessed to determine if the value is FF. Since the main board is triggered from a suspended state, FF is the normal value. Any abnormality is registered by incrementing the error count by one in step S470. If the normal value FF is detected, step S455 is executed to determine if the number of tests has reached a preset value. If the preset number is still not reached, the test results are displayed in step S465 and the next testing loop is initiated by jumping back to step S430. On the other hand, if the preset number is reached, the test is complete. Results including total number of test cycles and the total number of error occurrences are displayed in step S460.

Procedure B for re-starting the computer main board as shown in FIG. 4B involves several steps. In step S480, the error count is incremented by one and a four-second delay is used to shut off power to the main board. In step S482, the number of S3 suspend/wake up tests are checked to determined if the preset number is reached. If the preset number is reached, step S484 is executed to display the test results followed by the termination step S490. Otherwise, step S410 is executed to turn on the power again till start-up is successful. Thereafter, step S420 for carrying out the S3 suspend/wake up testing is executed via step S415. Because the purpose of having this testing procedure is to conduct an S3 suspend/wake up test, the procedure B may be replaced by an ending step to stop the test since the S3 suspend/wake up testing operation reset test, in a meaning, cannot be performed due to the unsuccessful start-up of the operating system.

Although the power management suspend/wake up testing chooses an ACPI S3 energy-saving mode as an example, this invention may be applied to test other types of energy-saving modes and states.

This invention also provides a method of testing the on/off switching of a computer main board. According to a preset testing procedure, test control commands are issued sequentially to control the switching and resetting of a computer main board. A write-in data from a specified address port is translated by a standard interface on the computer main board so that functionality of the computer main board can be determined. The test results are recorded and finally displayed.

The test control commands include a power on/off command and a reset command. The preset test procedure includes steps for conducting an on/off test, a reset test and a power management suspend/wake up test. The standard interface of the computer main board is a PCI interface and the special port address for detecting errors is the input/output port address 80H. Furthermore, the testing method also displays test results that include the number of tests and the number of errors. Moreover, the interval separating each test control command can be preset.

In summary, the computer main board on/off testing device, method and system according to this invention conducts on/off tests, reset tests and power management suspend/wake up tests automatically instead of manually. In addition, the number of repeated tests and the testing interval may be adjusted on demand. Since the testing results are registered and displayed automatically, performance of the testing system is improved and the results are more reliable.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A computer main board on/off testing device, comprising:a command translation unit, coupled to the computer main board through a standard interface for receiving and translating a write-in data from a specified port address and latching up the translated write-in data; anda test procedure control unit, coupled to the command translation unit and the computer main board for issuing test control commands according to a preset testing procedure and reading the latched write-in data inside the command translation unit so that functionality of the computer main board is assessed and results are registered.

2. The computer main board on/off testing device of claim 1, further comprising a test result display unit for displaying the test results.

3. The computer main board on/off testing device of claim 1, further comprising a test procedure selection unit coupled to the test procedure control unit for selecting the preset testing procedure loop.

4. The computer main board on/off testing device of claim 1, wherein the preset testing procedure comprises at least one of the following test procedures: on/off test procedure, reset test procedure, and power management suspend/wake up test procedure.

5. The computer main board on/off testing device of claim 1, further comprising a write-in data display unit for displaying the write-in data.

6. The computer main board on/off testing device of claim 1, wherein the test control command comprises at least one of the following commands: power switching command and reset command.

7. The computer main board on/off testing device of claim 1, wherein a time interval between execution of test control commands is programmable.

8. The computer main board on/off testing device of claim 1, wherein the test procedure control unit comprises a microprocessor, a latching device and a read-only-memory (ROM) unit.

9. A computer main board on/off testing system, comprising:a computer main board; anda computer main board testing device connected to a standard interface on the computer main board, wherein the testing device controls the switching and resetting of the computer main board so that test control commands are sequentially transmitted according to a preset testing procedure.

10. The computer main board on/off testing system of claim 9, wherein the computer main board testing device further comprises a unit for displaying the test results.

11. The computer main board on/off testing system of claim 9, wherein the test control command comprises at least one of the following commands: power switching command and a reset command.

12. The computer main board on/off testing system of claim 9, wherein the preset testing procedure comprises at least one of the following test procedures: switching test procedure, reset test procedure, and power management suspend/wake up test procedure.

13. The computer main board on/off testing system of claim 9, wherein write-in data from a specified port address is read and translated by the standard interface so that functionality of the computer main board is assessed and test results are registered.

14. The computer main board on/off testing system of claim 9, wherein the test results comprises an error count.

15. A computer main board on/off testing method, comprising the steps of:sequentially issuing test control commands according to a preset testing procedure for controlling the switching and resetting of the computer main board; andretrieving write-in data from a specified port address; andtranslating the write-in data through a standard interface on the computer main board so that functionality of the computer main board is assessed and test results are registered.

16. The computer main board on/off testing method of claim 15, further comprising the step of displaying the test results.

17. The computer main board on/off testing method of claim 15, wherein the test control command comprises at least one of the following commands: power switching command and reset command.

18. The computer main board on/off testing method of claim 15, wherein the preset testing procedure further comprises at least one of the following test procedures: on/off test procedure, reset test procedure and power management suspend/wake up test procedure.

19. The computer main board on/off testing method of claim 15, wherein a time interval between execution of test control commands is programmable.

20. The computer main board on/off testing method of claim 15, wherein the computer further comprises a computer main board and a computer main board on/off testing device connected to the computer main board for controlling the switching and resetting of the computer main board through a set of connection lines.
